(19) United States
(12) Patent Application Publication
(10) Pub. No.: US 2007/0153966 A1
(43) Pub. Date: Jul. 5, 2007

(54) Method for producing ceramic nuclear fuel tablets, device and container for carrying out said method

(76) Inventor: Valery Alexandrovich Astafiev, Moscow (RU)

Correspondence Address: John B Hardaway, III;Nexsen Pruet, LLC, P.O. Box 10107, Greenville, SC, 29603, US

(21) Appl. No.: 10/574,093

(22) PCT Filed: Sep. 29, 2003
(86) PCT No.: PCT/RU03/00422

§ 371 Date: Jul. 31, 2006

(51) Int. Cl. G21C 3/36

(52) U.S. Cl. 376/432

(57) ABSTRACT

The invention relates to nuclear engineering. The inventive method for producing ceramic nuclear fuel tablets consists in preparing, granulating and pressing a moulding powder and in sintering the thus obtained tablets. The preparation stage consisting in grinding and mixing is carried out by means of ferromagnetic needles (7) in a container (4) under magnetic field action. The inventive device for preparing the moulding powder comprises a protective chamber (12), a grinding and mixing unit embodied in the form of an inductor coil (10). A tube (9) which is made of a non-magnetic material and in which the container (4) is arranged is introduced into the inductor coil (10). Said device also comprises a powder granulation unit, a container conveying and positioning system provided with elements for vertically displacing (8, 13) and turning (14) said container. The protective chamber (12) is embodied in the form of a circuit in such a way that the container (4) is displaceable therein. Said container (4) is made of a non-magnetic material in the form of a cylinder and provided on the end surface thereof with a valve (6) which is connected to a cylindrical tank (21) by means of a flange joint (25a, 25b). The valve (6) has an internal cavity which is separated from the cylindrical tank by a transversal mesh partition (26) impenetrable for the ferromagnetic needles (7) Said invention is characterised in that it improves the powder mixing efficiency.

### TECHNICAL FIELD

The present invention relates to nuclear engineering and can find application for producing homogeneous nuclear fuel from a mixture of ceramic powders of fissionable components and various additives for fast-and thermal-neutron reactors. More particularly, the invention can find utility when used in the manufacturing process of ceramic nuclear fuel tablets (hereinafter referred to as tablets) for producing fuel elements made use of in the cores of nuclear reactors of electric power stations, e.g., tablets from uranium and plutonium dioxides (hereinafter referred to as mixed fuel), the content of various additives being from 0.05 percent by weight.

### BACKGROUND ART

The manufacturing process of the tablets comprises the steps of preparing a molding powder, pressing and sintering the thus-prepared tablets. When tablets are manufactured from a number of components, e.g., from uranium and plutonium oxides, the step of the molding powder preparation comprises the operation of grinding and mixing the starting powders. It is said operation that the principal characteristics of finished tablets depend on, that is, homogeneity of the solid solution, density, grain size, microstructure, and so on, which govern the working efficiency of nuclear fuel in the reactor.

One state-of-the-art method for preparing a molding powder by intermixing the starting uranium oxide and plutonium oxide powders, pressing the resultant mixture and sintering the resultant tablets (cf. PCT Application 96/25,746, IPC G 21 C 3/62, published Aug. 22, 1996). According to said method, the molding powder is prepared by grinding and mixing together the components in a ball mill. The method suffers from a low grinding and mixing efficiency of the powders. As a result, the structure of the sintered tablets is composed of two phases, whereby the required homogeneity of the mixed fuel is unattainable. The finished tablets are poorly dissoluble in nitric acid which affects adversely realizing a closed fuel cycle.

Another prior-art method of manufacturing tablets for fuel elements of thermal-neutron reactors from (U,Pu)O₂, comprising premixing powdered uranium and plutonium oxides in a V-shaped mixer and grinding the resultant mixture for 20 hours in a ball or hammer mill, followed by pressing and sintering the tablets [cf. “Development, manufacture and operation of fuel elements in nuclear power reactors”, a textbook by F. G. Reshetnikov, Yu. K. Bibilashvili et al., Book 1, Moscow, Energoatomizdat PH, 1995, p.110 (in Russian)]. The method under consideration also suffers from a low grinding and intermixing efficiency of the powders which prevents attaining the required homogeneity of the mixed fuel. Furthermore, the process suffers from low productive capacity and complicated providing nuclear safety for production processes. Besides, too a prolonged operation of grinding and intermixing the powders leads to a severe wear on the grinding bodies and the mixer walls and soiling the molding powder with harmful impurities.

A method for preparing a homogeneous nuclear fuel from a mixture of dioxides of uranium and plutonium for producing tablets, comprising the steps of preparing a molding powder in a vortex bed, granulating and sintering of tablets (cf. RU Pat. #2122247, IPC⁶ G 21 C 21/00). The vortex bed in the effective volume of a cylindrical mixer is established due to an intense motion of magnetic needles under the effect of a variable magnetic field. It is under the action of said needles that the powders are intermixed and further disintegrated, as well as activation the powder mixture particles. The method in question is in fact the closest to the method proposed herein and is therefore elected as the prototype.

Known in the art presently is a device for carrying the prototype method into effect, said device comprising an inductor with a coil shaped as a cylinder with a central opening having its axis arranged horizontally. A tube of a non-magnetic material is put inside the coil interior for receiving a hermetically sealed cylinder-shaped container of a non-magnetic material, e.g., titanium, adapted to hold the powders to be mixed together, and needles from a ferromagnetic material (cf. RU Pat. #2122247, IPC⁶ G 21 C 21/00). For more efficient grinding and intermixing processes the device is provided with means for imparting horizontal reciprocation to the container inside the tube. The discussed before is in fact the closest to the proposed one and is therefore elected as the prototype.

One prior-art container for grinding and intermixing powders is known to appear as a cylinder-shaped cup having a cylinder-shaped sealed cover, both said cup and said cover being made of a non-magnetic material (cf. RU Pat. #2122247, IPC⁶ G 21 C 21/00). The container under discussion is the closest to the proposed one and is therefore elected as the prototype.

The stage of preparing a molding powder carried out in accordance with the prototype method using the device and container described before, comprises the following steps: charging the starting powders of uranium and plutonium dioxides, the grinding process initiating agents, as well as the ferromagnetic needles into the container cup; hermetically sealing the container using a removable cover; putting the container together with the powders and needles into the interior of the horizontal tube placed inside the inductor coil; grinding and mixing the powders together under the action of the ferromagnetic needles moving in the inductor magnetic field upon the container reciprocating motions inside the tube; withdrawing the container from the tube; cooling the container together with the contents thereof; uncovering the container and discharging-the resultant powder mixture and the needles; separating the powder from the needles; putting the container into a granulation unit. The container cup is charged with uranium and plutonium dioxides for 50-70% of, its holding capacity, and the total weight of the magnetic needles being loaded should not exceed half the critical mass value at which the needles cease rotating in the container electromagnetic field. Geometric shape and the ratio of the geometric dimensions of the ferromagnetic needles are of substantial significance in the method proposed herein; thus, for instance, the ratio of the needle length to the diameter thereof should range from 8 to 14. Charging the starting powders into the container may be accompanied by adding special dopants thereto, e.g., burnable neutron absorbers.

The molding powder preparing operation described before suffers from inadequately efficacious intermixing and grinding of powders for the reasons laid down below. The rotation zone of the inductor variable magnetic field under the effect of which the ferromagnetic needles are moving, is substantially smaller than the height of the cylinder-shaped container. Therefore during the operation a considerable proportion of the powder proves to be off the zone of effect of the electromagnetic field on the ferromagnetic needles, since the powder is spread in a layer over the entire length of the horizontal container. That is why in the course of mixing the powders together one has to set the container in reciprocating motion with a definite amplitude inside the horizontal tube. However, such being the case the conditions for grinding and intermixing of the powders in the end container zones differ strikingly from those at the center thereof, thus affecting adversely the efficiency of the process, extending the time spent for the operation and deteriorating the characteristics of the resultant mixture. Moreover, such a process comprises a great deal of elementary steps (e.g., separating the powder from the needles, loading the needles to the container, motion of the container) and is therefore hardly amenable to automation which is of importance with a viewpoint of providing safety for producing a mixed nuclear fuel.

One more disadvantage inherent in the known method resides in low container cooling efficiency in the course of grinding and intermixing of the powders, this being due to horizontal arrangement of the container in the tube, and a badly affected efficiency of convective cooling of the container holding the powder. As a result, once the powders held in the container are treated, in accordance with the prototype method, for 6-10 min., the container is heated up to a temperature of about 100° C. which extends the container cooling time before its unsealing and emptying.

### SUMMARY OF THE INVENTION

It is a primary and essential object of the present invention to add to the efficiency of the grinding and intermixing of powders and to attain the required characteristics of the resultant powder mixture necessary for preparing a homogeneous mixed nuclear fuel having different composition, e.g., comprising a high-background recovered plutonium or various additives in an amount of from 0.05 percent by weight.

Said object is accomplished due to the fact that in a known method for producing a homogeneous nuclear fuel appearing-as tablets from a powder mixture (which method comprises the steps of preparing a molding powder, its granulation, pressing and sintering the resultant tablets, wherein the steps of preparing the molding powder comprises the following operations: charging the dosages of starting powdered components and a grinding process initiating agent, as well as the ferromagnetic needles into a container made of a non-magnetic material; hermetically sealing the container; putting the container together with the powders and ferromagnetic needles into the interior of the tube made of a non-magnetic material placed inside the inductor coil; grinding and intermixing the powders under the action of the ferromagnetic needles moving in the inductor magnetic field; withdrawing the container from the tube; cooling the container; unsealing the container and discharging the resultant powder mixture therefrom into the granulation unit), there are established in the container interior a cylinder-shaped working zone adapted to permanently accommodate the ferromagnetic needles, and an end zone, both of said zones are isolated from each other by a meshed partition, the dosages of the powders are charged into the working zone through the end zone and a sieve, the container is put into the tube interior for the height of the container working zone, said tube being positioned vertically inside the inductor coil, the powders are treated by virtue of the ferromagnetic needles moving in the working zone, and the resultant powder mixture is discharged from the container via the meshed partition and the end zone without unloading the ferromagnetic needles from the working zone.

According to a particular embodiment of the herein-proposed method, the weight of the ferromagnetic needles being loaded are set to be from 2.5% to 90% of the critical mass upon exceeding of which the needles stop rotating in the mixer electromagnetic field.

According to another particular embodiment of the method, the critical mass of the ferromagnetic needles is calculated by the formula:
m_{cr}=K_{cr}·V_{c}·ρₙ,
wherein K_{cr} is the criticality factor of loading the mixer with the needles; V_{c} is the container interior volume corresponding to the height of the electromagnetic field rotation zone; ρₙ is the density of the needle material.

According to one more particular embodiment of the method, a total volume of the ceramic powders to be charged into the container is set to be not in excess of 90% of a free volume thereof falling on the electromagnetic field rotation zone.

According to a still more particular embodiment of the method, use is made of ferromagnetic needles, wherein the ratio of the length thereof to their diameter varies from 8 to 14.

According to a yet still more particular embodiment of the method, the ratio of a total weight of ceramic powders to the weight of ferromagnetic needles is set to range from 0.3 to 3.0, predominantly from 0.5 to 2.0.

According to a further particular embodiment of the method, rotation frequency of the electromagnetic field is set to be from 10 to 50 Hz.

According to a still further particular embodiment of the method, the powders are ground and mixed together for 1-20 minutes.

According to a yet still further particular embodiment of the method, the powders are ground and mixed together in a number of cycles for 1-10 minutes.

According to another particular embodiment of the method, all operations at the step of preparing the molding powder are conducted in an inert gas atmosphere.

The object of the invention is accomplished also due to the fact that in a known device (comprising a protective chamber, a unit for charging dosages of starting powdered components and a grinding process initiating agent into the container, a grinding and intermixing unit for the powders, appearing as an inductor having a coil inside which a tube of a non-magnetic material is put, adapted to receive a hermetically sealed cylinder-shaped container of a non-magnetic material adapted to hold the powders and needles from a ferromagnetic material, a powder granulation unit, as well as a container conveying and positioning system), said grinding and intermixing unit for the powders involves vertically arranged axes of said inductor and said tube, the tube is blanked off at the lower end thereof to form a fragment of the protective chamber, said protective chamber appears as a circuit and the container is adapted to move over said circuit from the charging unit towards the grinding and intermixing unit, next to the granulation unit and finally to the charging unit, said circuit of the protective chamber is formed by process boxes adapted to accommodate the units of the device, and by conveying boxes, and the container conveying and positioning system is provided with elements for vertically moving the container in the zone of charging unit and the zone of grinding and intermixing unit, and for tipping over said container to discharge the powder in the zone of the mixture granulation unit.

According to another particular embodiment of the device, the protective chamber is filled with an inert gas atmosphere.

According to one more particular embodiment of the device, the protective chamber is provided with a conveying box for the container to withdraw from said protective chamber circuit.

According to still one more particular embodiment of the device, the housing of the protective chamber is functionally combined with the load-bearing framework of the structure of said device.

According to yet still one more particular embodiment of the device, the inductor with the coil is disposed on the outside of said protective chamber.

The object of the invention is accomplished also due to the fact that in. a known container for carrying the proposed method into effect (said container appearing as a cylinder-shaped vessel from a non-magnetic material having a hermetic sealing unit at an end face thereof), said hermetic sealing unit appearing as a valve having an interior space isolated from the cylinder-shaped vessel by a transversal meshed partition and connected to said cylindrical vessel via a flanged joint.

According to another particular embodiment of the container, said flanged joint is separable.

According to one more particular embodiment of the container, said valve appears as a ball cock provided with a drive mechanism for the cock to rotate.

According to still more particular embodiment of the container, said flanged joint is provided with a platform for the container to be fixed stationary and positioned.

According to yet still more particular embodiment of the container, the inner cylindrical surface of said vessel has a chamfered junction to a flat bottom thereof.

### BRIEF DESCRIPTION OF THE DRAWINGS

The essence of the invention is illustrated by the following four accompanying drawings.

FIG. 1 presents a functional diagram which illustrates carrying the proposed method into effect with the aid of the device and container being claimed;

FIG.2 shows a schematic diagram of the protective chamber;

FIG.3 is a general view of the proposed container; and

FIG.4 presents data on a grain size and distribution of plutonium concentration b over the surface of a polished specimen a for the proposed method and the corresponding data c and d for the prototype method.

### VARIANTS OF PARTICULAR EMBODIMENTS OF INVENTION

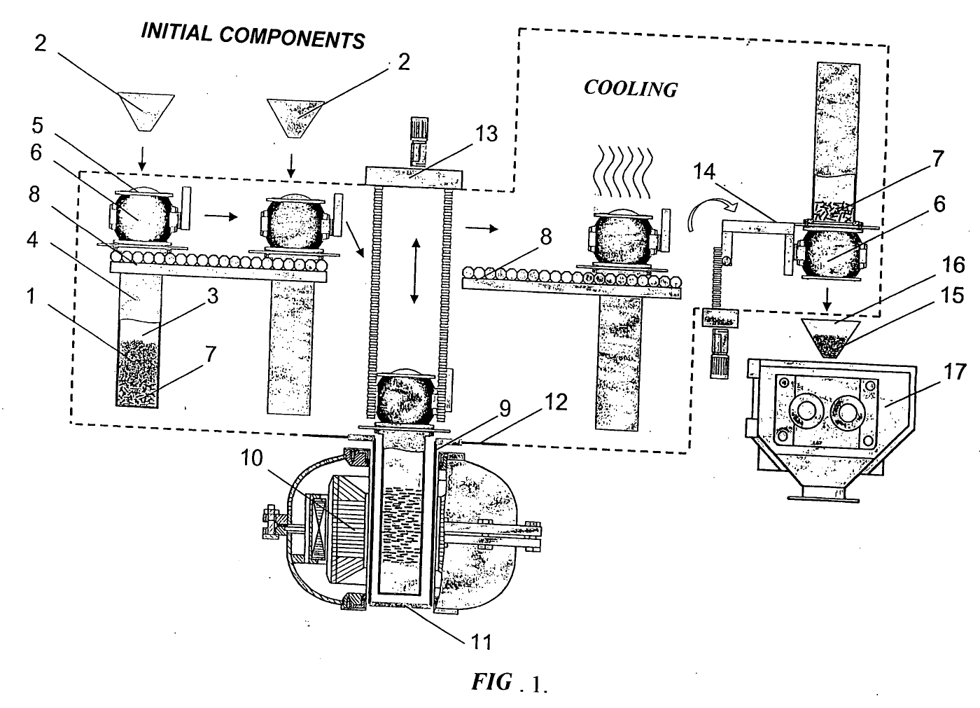

Carrying the method into effect and the operating principle of the device are illustrated by the diagram shown in FIG. 1.

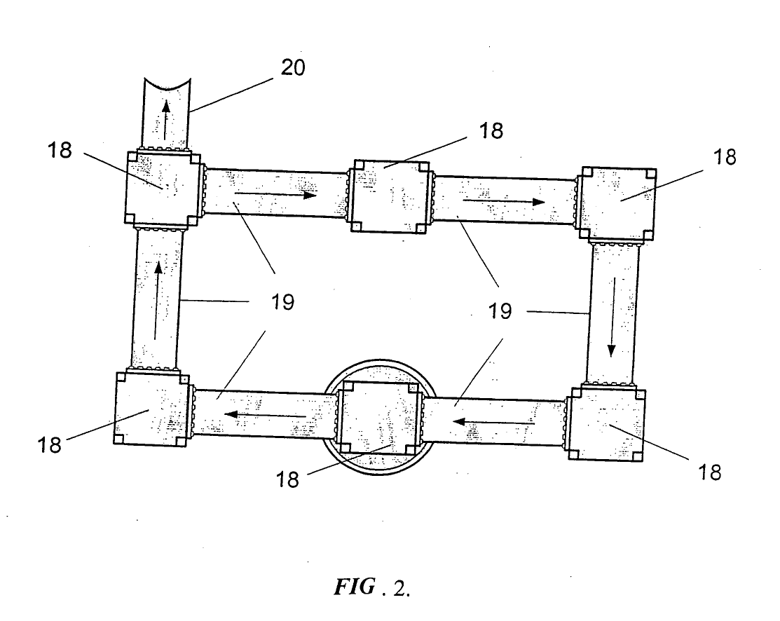

Starting powders 1, e.g., powdered uranium dioxide and plutonium dioxide, a grinding process initiating agent, and other additives are fed from batching hoppers 2, via an end zone 5 of a valve 6 and a meshed partition (not shown in FIG.1), to an working zone 3 of a container 4, wherein ferromagnetic needles 7 are kept constantly. The container 4 is conveyed, by means of a conveying and positioning system 8 thereof, to the grinding and intermixing unit towards a vertical tube 9 put into a coil 10 of an electromagnetic vortex mixer. A blank plug 11 is provided at the lower end of the tube 9. Said tube 9 is secured, in the area of the upper open end thereof, on the wall of the protective chamber 12 and is in fact a fragment thereof; (the geometry of the protective chamber is shown in FIG. 1 schematically, the general view of a variant of the chamber geometry being shown in FIG.2). The container 4 is moved vertically downwards along the axis of the tube 9, using an element 13. and is fixed stationary therein so that the container working zone 3 should align with the working zone of the mixer coil 10. As a result, a variable electromagnetic field is excited, having a preset rotation frequency, said field producing an effect on the ferromagnetic needles 7. It is under said effect that said ferromagnetic needles are made to perform compound rotary motions in the working zone of the container 4, thereby further disintegrating and intermixing the. powdered components. Next the container 4 is actuated by the element 13 to move upwards and return onto the conveyor of the system 8, is cooled down, moved towards the granulation unit and tipped over using an element 14, whereupon the valve 6 is opened and a powder mixture 15 is discharged via the meshed partition (not shown in FIG. 1) and the end zone 5 into a receiving hopper 16 of the granulation unit 17. The ferromagnetic needles 7 remain in this case on said meshed partition in the container working zone 3. Then the container 4 together with the ferromagnetic needles 7 are returned to the charging unit to receive a next dosage of the starting powders. The resultant mixture of powders is granulated, pressed and sintered according to known techniques.

A general view of a variant of the protective chamber geometry is shown in FIG. 2. The chamber appears as a circuit adapted for the container to move there inside along the following circular pathway: charging unit-grinding and intermixing unit-granulation unit-charging unit. The circuit of the protective chamber is established by process boxes 18 for disposing the units of the device and conveying boxes 19 intended for moving and positioning the container in the circuit. The protective chamber is provided with an additional conveying box 20 for the containers to put into and withdraw from the circuit.

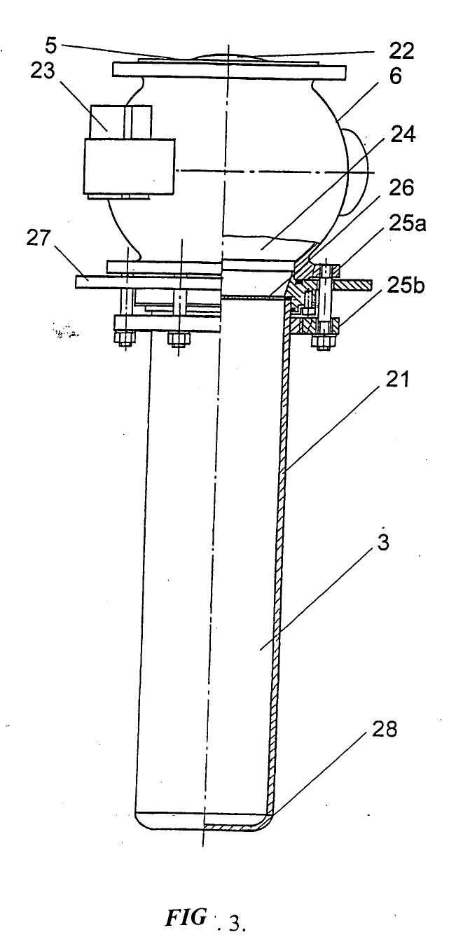

The container (FIG. 3) comprises a cylinder-shaped vessel 21 made of a non-magnetic material, e.g., titanium, a hermetic sealing unit appearing as the valve 6 having a spherical core 22 which is provided with a drive mechanism 23 for the core to rotate inside an interior space 24 of the valve 6. Said valve is made of a non-magnetic material, such as stainless steel. Both the valve 6 and the cylinder-shaped vessel 21 are interconnected through a flanged joint 25a and 25b and isolated from each other by a transversal meshed partition 26 which is impervious to ferromagnetic needles. Said flanged joint 25a and 25b may be separable for the ferromagnetic needles (not shown in FIG. 3) or the meshed partition 26 to replace. The container is provided with a platform 27 for said container fixing in place or positioning. To reduce resistance to rotation of the needles and ruling out the danger of forming dead zones, the inner cylindrical surface of the vessel mates together with the flat bottom thereof through a junction 28.

Practical realization of the proposed method enabled one to obtain empirical relationships instrumental in adding to the efficiency of the process of grinding and intermixing the starting powders. It has been ascertained a substantial influence of the size of needles and the weight of their charge into the container on the process of grinding and intermixing the starting powders. Hence the grinding and intermixing processes proceed most efficiently with the needle length-to-diameter ratio of from 8 to 14.

The ratio between the weight of needles being charged and the weight of the starting powders influences the coursing of the process, too, said ratio depending on a preset capacity of the mixing process, ingress of undesirable impurities resulting from attrition, and the mass M_{cr} of critical charge of the working container with the needles. The absolute value of M_{cr} is calculated according to the following formula:
m_{cr}=K_{cr}·V_{c}·ρₙ,
wherein K_{cr} is the criticality factor of loading the mixer with the needles; V_{c} is the container interior volume corresponding to the height of the electromagnetic field rotation zone; ρₙ is the density of the needle material. The value of K_{cr} is found experimentally for each type of needles and is equal to the ratio between the container volume located in the electromagnetic field effective zone and the total volume of all needles charged at which ratio the needles cease moving.

It is experimentally found the conditions of a minimum metal fretting depending on charge of ferromagnetic needles, treatment time and material of the needles. It is recommendable to use ferromagnetic needles from ball-bearing steel, grade ShKh-15 or ShKh-45 (IIIX-15 or IIIX-45) having the following dimensions: diameter d=0.2 cm, length l=2 cm. The criticality factor of loading K_{cr} for such needles is 0.1. Use was made of a container having an interior volume located in the electromagnetic field rotation zone, V_{c} =2713 cm³ (which is a maximum volume for the used mixer ABC-150 having a length L of the working zone equal to 24 cm and a maximum allowable container diameter D=12 cm), the density of the needle material ρₙ 7.5 cm^{3.}

A maximum possible (as far as contamination of the powders with impurities is concerned) ratio f between the weight of needles and the weight of powder is 2, a minimum allowable value of f depends on disintegration efficiency and equals 0.3.

The numerical value of m_{cr}≈1800 g. The recommendable amount of charge of the working container with the powder ranges from 0.6 to 3.6 kg, and the container may be charged by not more than 90% its free capacity falling on the working zone of electromagnetic field.

It is found experimentally that with the electromagnetic field rotation frequency reduced from 50 to 30 Hz the grinding and intermixing efficiency of the powders remains practically unaffected, and the temperature of the outer walls of the container titanium cup after the operation is found to have dropped by approximately 50° C.

All molding-powder preparing operations in experiments with radioactive and pyrophorous powders were performed in a shielded box filled with an inert gas atmosphere.

### SPECIFIC EXEMPLARY EMBODIMENTS OF INVENTION

### Example 1

Preparing tablets of a mixed uranium-plutonium nuclear fuel from starting uranium dioxide powders as per Specifications TU 52 000-28 (TY 52 000-28) and plutonium dioxide powders as per Specifications TU 95.2-79 (TY 95.2-79), as well as zinc stearate taken in respective amount of 95 g, 5 g and 0.2 g and a total weight of the starting powders of 100.2 g. The process of grinding and intermixing the powders is carried out in a titanium container having an working zone measuring 12 cm in diameter and 24 cm in height, using needles from steel grade SH KH-15 (IIX-15) measuring 0.2 cm in diameter and 2 cm in length and a vortex mixer having a working zone 24 cm long and an opening 13 cm in diameter for the container to dispose.

Then a critical mass of charge of the working container with the needles is calculated by the formula:
m_{cr}=K_{cr}·V_{c}·ρₙ,

wherein K_{cr} is the criticality factor of loading the mixer with the needles, equal to 0.1; V_{c} is the container interior volume falling on the height of the electromagnetic field rotation zone, equal to 2713 cm³; ρₙ, is the density of the needle material, equal to 7.5 g/cm³, whereby the value of m_{cr} is 2000 g. Next the needles having a total weight of 200 g are charged into the container, the ratio between the weight of the needles and the weight of the powder being 2 and the volume of the powder in the container ˜50 cm³ which makes up ˜1.9% of a free container volume falling on the working zone of the electromagnetic field. Thereupon a meshed partition made of brass and having a mesh size of 1 mm is put onto the cylinder-shaped vessel, as well as the hermetic sealing unit appearing as type [symbol] Y-120 ball valve, and the container flanged joint is sealed hermetically. Next the aforementioned dosages of the starting powders are charged into the working zone of the container accommodated in the argon-filled protective chamber, via the valve interior space and the meshed partition, the container is sealed hermetically and the powders are intermixed in type ABC-150 vortex mixer at an electromagnetic field rotation frequency of 30 Hz for a single cycle lasting 4 min. Then the container is cooled for 5 min and the powder mixture is discharged into type L200/30P granulation unit. The resultant granulate is pressed into crude tablets having a diameter of ˜7.2 mm, a height of ˜6 mm and a density of 6.5 g/cm³. The thus-prepared tablets are sintered in an argon-hydrogen medium at 1750° C. for 3 h.

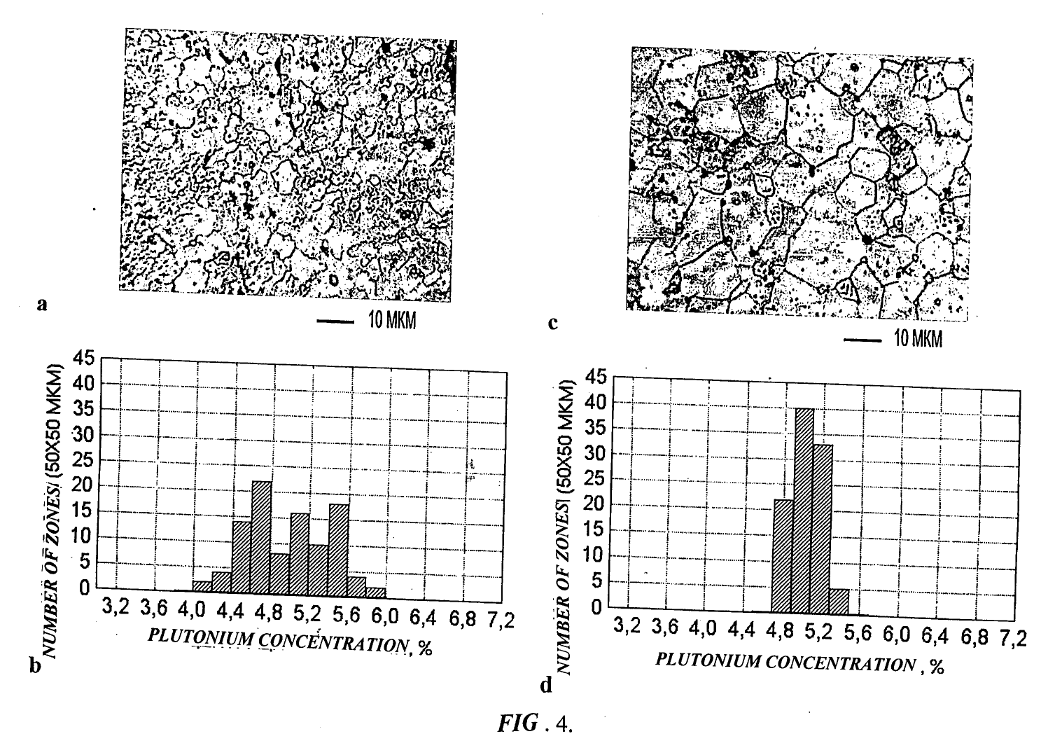

Then the resultant tablets are examined under an electronic scanning microscope and metallographically. Comparison results of examination of the tablets prepared using the proposed invention and the prototype method are presented in FIG. 4. The results obtained demonstrate that preparing a molding powder by the proposed method provides for a homogeneous structure of the solid solution of (U,Pu)O₂ of a mixed fuel featuring a uniform distribution of the components over the entire mass of a tablet (cf. data a and b in FIG. 4), and said data exceed substantially the respective characteristics of the prototype method (cf. data c and d in FIG. 4). Furthermore, there is provided complete solubility of the tablets of such a fuel in nitric acid, which is of great importance when recovering a mixed fuel.

### Example 2

Preparing tablets of a mixed uranium fuel of corrected enrichment from starting powders of depleted uranium dioxide (U-235 content of 0.24%) and highly enriched uranium dioxide (U-235 content of 90%), grade TU 95.604-84 (TY 95.604-84), as well as commercial-origin zinc stearate, taken in respective amounts of 99.95 g, 0.05 g and 0.2 g and a total weight of the starting powders equal to 100.2 g.

Next a molding powder is prepared, tablets are pressed and sintered as described in Example 1.

Thereupon the resultant tablets are subjected to examination by metallographic analysis and gamma-spectrometry. An average U-235 isotope content of the tablets is 0.28%, a root-mean-square deviation of the U-235 concentration of ten specimens is 0.004%.

### INDUSTRIAL APPLICABILITY

Results of examination of the tablets produced using the proposed invention demonstrate that preparing a molding powder by the proposed method provides for a homogeneous structure of a mixed fuel having its components distributed uniformly over the entire volume of a tablet.

Hence use of the proposed method for producing a homogeneous mixed nuclear fuel will enable one to gain substantial advantages over the known methods, namely, higher homogeneity and a substantial increase of the grain size in the tablets of a mixed ceramic fuel; an efficient use of the electromagnetic mixer working zone which may be charged with powders and needles; a reduced period of grinding and intermixing the starting powders due to intensified processes proceeding in the working zone of the vertically arranged container; simple and easy establishing, on the basis of the techniques proposed herein, a high-capacity plant for producing mixed ceramic fuel; simple provision of nuclear safety of the production techniques used.

1. A method for producing tablets of a ceramic nuclear fuel comprising the steps of preparing a molding powder, its granulation, pressing and sintering the resultant tablets, wherein the steps of preparing the molding powder comprises the operations of charging the dosages of starting powdered components and a grinding process initiating agent into a container made of a non-magnetic material, hermetically sealing the container, putting the container together with the powders and ferromagnetic needles into the interior of the tube made of a non-magnetic material placed inside the inductor coil, grinding and intermixing the powders under the action of the ferromagnetic needles moving in the inductor magnetic field, withdrawing the container from the tube, cooling the container, unsealing the container, and discharging the resultant powder mixture therefrom into the granulation unit, CHARACTERIZED in that there are established in the container interior a cylinder-shaped working zone adapted to constantly accommodate the ferromagnetic needles, and an end zone, both of said zones are isolated from each other by a meshed partition impervious to the needles, the dosages of the powders are charged into the working zone through the end zone and the meshed partition, the container is put into the tube interior for the height of the container working zone, said tube being positioned vertically inside the inductor coil, the powders are treated by virtue of the ferromagnetic needles moving in the working zone, and the resultant powder mixture is discharged from the container via the meshed partition and the end zone without unloading the ferromagnetic needles from the working zone.

2. A method as claimed in claim 1, CHARACTERIZED in that the weight of the ferromagnetic needles being loaded are set to be from 2.5% to 90% of the critical mass upon exceeding of which the needles stop rotating in the mixer electromagnetic field.

3. A method as claimed in claim 1, CHARACTERIZED in that the critical mass of the ferromagnetic needles is calculated by the formula:
m_{cr}=K_{cr}·V_{c}·ρₙ,
wherein K_{cr} is the criticality factor of loading the mixer with the needles; V_{c} is the container interior volume corresponding to the height of the electromagnetic field rotation zone; ρₙ is the density of the needle material.

4. A method as claimed in claim 1, CHARACTERIZED in that a total volume of the ceramic powders to be charged into the container is set to be not in excess of 90% of a free volume thereof falling on the electromagnetic field rotation zone.

5. A method as claimed in claim 1, CHARACTERIZED in that use is made of ferromagnetic needles, wherein the ratio of the length thereof to their diameter varies from 8 to 14.

6. A method as claimed in claims 1, 2, 3 and 4, CHARACTERIZED in that the ratio of a total weight of ceramic powders to the weight of ferromagnetic needles is set to range from 0.3 to 3.0, predominantly from 0.5 to 2.0.

7. A method as claimed in claim 1, CHARACTERIZED in that rotation frequency of the electromagnetic field is set to be from 10 to 50 Hz.

8. A method as claimed in claim 1, CHARACTERIZED in that the powders are ground and mixed together for 1-20 minutes.

9. A method as claimed in claim 8, CHARACTERIZED in that the powders are ground and mixed together in a number of cycles for 1-10 minutes.

10. A method as claimed in claim 1, CHARACTERIZED in that all operations at the step of preparing the molding powder are conducted in an inert gas atmosphere.

11. A device for preparing the molding powder in order to carry said method into effect, comprising a protective chamber, a unit for charging dosages of starting powdered components and a grinding process initiating agent into the container, a grinding and intermixing unit for the powders appearing as an inductor having a coil inside which a tube from a non-magnetic material is put, adapted to receive a hermetically sealed cylinder-shaped container from a non-magnetic material adapted to hold the powders and needles from a ferromagnetic material, a powder granulation unit, as well as a container conveying and positioning system, said grinding and intermixing unit for the powders involves vertically arranged axes of said inductor and of said tube, the tube is blanked off at the lower end thereof to form a fragment of the protective chamber, said protective chamber appears as a circuit and the container is adapted to perform circular motion over said circuit from the charging unit towards the grinding and intermixing unit, next to the granulation unit and again to the charging unit, said circuit of the protective chamber is formed by the process boxes adapted to accommodate the units of the device, and by conveying boxes, and the container conveying and positioning system is provided with elements for vertically moving the container along the tube axis and for tipping over said container to discharge the powder in the zone of the mixture granulation unit.

12. A device as claimed in claim 11, CHARACTERIZED in that the protective chamber is filled with an inert gas atmosphere.

13. A device as claimed in claim 11, CHARACTERIZED in that the protective chamber is provided with a conveying box for the container to withdraw from the protective chamber circuit.

14. A device as claimed in claim 11, CHARACTERIZED in that the housing of the protective chamber is functionally combined with the load-bearing framework of the structure of said device.

15. A device as claimed in claim 11, CHARACTERIZED in that the inductor with the coil is disposed on the outside of said protective chamber.

16. A container for carrying said method into effect, appearing as a cylinder-shaped vessel from a non-magnetic material provided with a sealing unit at an end thereof, CHARACTERIZED in that the hermetic sealing unit appears as a valve having an-interior space isolated from the cylinder-shaped vessel of the container by a transversal meshed partition impervious to ferromagnetic needles, said valve being connected to said cylindrical vessel via a flanged joint.

17. A device as claimed in claim 16, CHARACTERIZED in that the flanged joint is separable.

18. A device as claimed in claim 16, CHARACTERIZED in that the valve appears as a ball cock provided with a drive mechanism mounted thereon for the cock to rotate.

19. A device as claimed in claim 16, CHARACTERIZED in that the flanged joint is provided with a platform for the container to be fixed stationary and positioned.

20. A device as claimed in claim 16, CHARACTERIZED in that the cylindrical portion of the vessel making part of the container working zone, on its inner side has a chamfered junction to a flat bottom thereof.
